(19) United States
(12) Patent Application Publication
(10) Pub. No.: US 2006/0165135 A1
(43) Pub. Date: Jul. 27, 2006

(54) Method for oscillating variable-pulse width laser and variable-pulse width laser equipment

(75) Inventors: Takayo Ogawa, Wako-Shi (JP); Satoshi Wada, Wako-Shi (JP); Yuji Oki, Fukuoka-Shi (JP); Yoshiharu Urata, Wako-Shi (JP)

Correspondence Address: BIRCH STEWART KOLASCH & BIRCH, PO BOX 747, FALLS CHURCH, VA, 22040-0747, US

(73) Assignees: RIKEN, Wako-Shi (JP); MEGAOPTO CO., LTD., Wako-Shi (JP)

(21) Appl. No.: 11/312,452

(22) Filed: Dec. 21, 2005

(30) Foreign Application Priority Data
Dec. 22, 2004 (JP) 2004-372129

(51) Int. Cl. H01S 3/113

(52) U.S. Cl. 372/11

(57) ABSTRACT

A saturable absorber functioning as a Q-switch is disposed on a path of a light in a laser resonator provided with a laser medium, the saturable absorber disposed in the laser resonator is transferred relatively toward the path of the light, and an initial transmittance of the saturable absorber in the case when the light passes through the saturable absorber is changed in order to achieve such effect that a scale of the whole equipment is not upsized, it is in excellent in workability and convenient, besides there is no fear of decreasing stability in a pulsed laser oscillation.

### BACKGROUND OF THE INVENTION

1. Field of the Invention

The present invention relates to a method for oscillating a variable-pulse width laser and variable-pulse width laser equipment, and more particularly to a method for oscillating a variable-pulse width laser and variable-pulse width laser equipment wherein a saturable absorber is used as a Q-switch element to pulse-oscillating a laser, whereby a pulsed laser radiation is output.

2. Description of the Related Art

Heretofore, a saturable absorber being a light absorption material involving such a property that it becomes transparent when intensity of the incident light is increased, in other words, absorption of the light becomes weak due to saturation of light absorption has been known. Under the circumstances, such pulse laser equipment that the saturable absorber as mentioned above is placed in a laser resonator and used as a Q-switch element, whereby laser output pulsed laser radiation is put into practice.

Namely, pulse oscillation of laser is achieved in such conventional pulse laser equipment wherein such saturable absorber is used as its Q-switch element by means of a shutter operation which uses such property of the saturable absorber that absorption coefficient of light is decreased to elevate a transmittance of light as increasing of incident intensity of the light.

In the meantime, it has been known that a pulse width of pulse laser radiation from a conventional pulse laser equipment wherein a saturable absorber is used as a Q-switch element is decided in every saturable absorbers used as Q-switch elements in response to changes in the above-described property of a saturable absorber, i.e. absorption coefficient of light accompanied with increase in light intensity and transmittance containing initial transmittance which are dependent on a composition of a saturable absorber and a light path length of a light passing through the saturable absorber.

Namely, according to such conventional pulsed laser equipment as described above, a pulse width of a pulsed laser oscillation cannot be changed unless a saturable absorber used as a Q-switch element is exchanged to another one.

Accordingly, when a pulse width of pulsed laser oscillation in conventional pulse laser equipment is intended to be changed, a plurality of saturable absorbers which are in response to desired pulse widths of pulsed laser oscillation, respectively, must be prepared, and in addition, complicated operations are required to exchange the saturable absorbers in response to pulse widths in every changes of such pulse widths. Thus, there is such a problem that a scale of the whole equipment becomes upsizing, and in addition, there are also problems of poor workability and lack of convenience.

On one hand, as the variable-pulse width laser equipment wherein, for example, an acousto-optic Q-switch (AO-Q switch) or an electro-optic Q-switch (EO-Q switch) is placed in a laser resonator as a Q-switch element is known as variable-pulse width laser equipment which can vary a pulse width of pulsed laser oscillation.

Namely, the AO-Q switch or the EO-Q switch is a Q-switch element which can control electrically a shutter operation. Accordingly, when a shutter operation of an AO-Q switch or an EO-Q switch is electrically controlled in variable-pulse width laser equipment wherein the AO-Q switch or the EO-Q switch is used, a pulse width of pulsed laser oscillation can be varied arbitrarily.

However, the variable-pulse width laser equipment wherein such AO-Q switch or EO-Q switch as described above is used requires electrically control system parts for controlling the AO-Q switch or the EO-Q switch, whereby a scale of the whole equipment becomes jumboized, so that there is also the problem of upsizing the scale of the equipment as that involved in the above-described former equipment wherein saturable absorbers are used as Q-switch elements.

Moreover, AO-Q switches or EO-Q switches are placed in a laser resonator of variable-pulse width laser equipment wherein the AO-Q switches or the EO-Q switches are used, whereby such electrical components are inserted into the laser resonator, so that these switches function as heat sources, resulting in elevation of a temperature in the variable-pulse width laser equipment. Thus, there arises another new problem of bringing about a cause for decreasing stability in pulsed laser oscillation.

### OBJECT AND SUMMARY OF THE INVENTION

The present invention has been made in view of the above-described various problems involved in the prior art, and an object of the invention is to provide a method for oscillating a variable-pulse width laser and variable-pulse width laser equipment which is adapted to be in such that a scale of the whole equipment is not upsized, it is in excellent in workability and convenient, besides there is no fear of decreasing stability in pulsed laser oscillation.

In order to achieve the above-described object, a method for oscillating a variable-pulse width laser and variable-pulse width laser equipment according to the present invention comprises a saturable absorber disposed as a Q-switch element in a laser resonator being transferred relatively toward the path of a light in the laser resonator, whereby an initial transmittance of the saturable absorber in the case when the light passes through the saturable absorber is changed.

Thus, according to the method for oscillating a variable-pulse width laser and variable-pulse width laser equipment of the invention, the initial transmittance of the saturable absorber can be changed in response to changes a light path length in the saturable absorber disposed in the laser resonator wherein the light passes through the saturable absorber. As a result of changing the transmittance of light in the saturable absorber, a timing of shutter operations comes to be changed. Therefore, continuous or step-by-step changes in a pulse width of pulsed laser radiation to be output can be achieved by a single saturable absorber disposed in a laser resonator as a Q-switch element. Such changes in a pulse width of pulsed laser oscillation could not have been achieved heretofore by means of a single saturable absorber so far as the saturable absorber disposed in the laser resonator as the Q-switch element is exchanged by another saturable absorber.

According to the method for oscillating a variable-pulse width laser and variable-pulse width laser equipment of the invention as described above, a scale of the whole equipment can be downsized, a degree of freedom of designing variable-pulse width laser equipment can be dramatically improved, the equipment is excellent in workability and convenient, and in addition, since there is no need to dispose any electric component in the laser resonator which will be a heat source, there is no fear of decreasing stability in pulsed laser oscillation.

Namely, a method for oscillating a variable-pulse width laser according to the invention comprises the steps of disposing a saturable absorber functioning as a Q-switch on a light path of a light in a laser resonator provided with a laser medium; transferring the saturable absorber disposed in the laser resonator relatively to the path of the light; and changing an initial transmittance of the saturable absorber when the light passes through the saturable absorber.

Furthermore, variable-pulse width laser equipment according to the invention comprises a laser resonator in which a laser medium is disposed; a saturable absorber which is located on a path of a light inside the laser resonator and functions as a Q-switch; and a transfer means for transferring the saturable absorber located in the laser resonator relatively to the path of the light to change an initial transmittance of the saturable absorber in the case when the light passes through the saturable absorber.

In the method for oscillating a variable-pulse width laser and the variable-pulse width laser equipment according to the invention, the saturable absorber to which a saturable absorber cooling accelerator may be united in order to diffuse the heat of the saturable absorber.

Further, in the method for oscillating a variable-pulse width laser and the variable-pulse width laser equipment according to the invention, the laser medium may be united with the saturable absorber cooling accelerator, and unify with the saturable absorber and the saturable absorber cooling accelerator.

Hence, the present invention provides such an excellent advantageous effect that a pulse width of pulsed laser radiation to be output can be changed without upsizing a scale of the whole equipment.

Moreover, the present invention provides such an excellent advantageous effect that workability in case of changing a pulse width of pulsed laser radiation is excellent and convenient, besides there is no fear of decreasing stability in pulsed laser oscillation.

The present invention may be used in the case where variable-pulse width laser equipment is manufactured in a laser equipment maker, or in the case where an experiment is carried out with the use of pulsed laser in a variety of laser experimental facilities.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 is a schematic constitutional plan view showing a state wherein variable-pulse width laser equipment according to an example of the manner of practice of the present invention is set out on an X-Y plane (a schematic constitution explanatory view taken along the Z-axis and when viewed from the direction of the arrow A in FIG. 2);

FIG. 2 is a schematic constitutional side view showing variable-pulse width laser equipment wherein only a part of a Q-switch unit is taken out and shown (a schematic constitution explanatory view when viewed from the direction of the arrow B in FIG. 1);

FIG. 3 is a perspective view showing a constitution of a Q-switch element;

FIG. 4 is a graphical representation showing results according to experiments of an inventor of this application wherein a relationship among changes of a light path length of a light in a saturable absorber through which the light passes, an initial transmittance of a Q-switch element, and a pulse width of pulsed laser output from a second mirror is represented in which the abscissa indicates the light path length of the light in the saturable absorber through which the light passes, the ordinate on the left side indicates the initial transmittance of the Q-switch element, and the ordinate on the right side indicates the pulse width of pulsed laser radiation from the second mirror;

FIG. 5 is a perspective view showing another manner of practice for a Q-switch element composed of only saturable absorbers;

FIG. 6(a) is a perspective view showing a further manner of practice illustrating a Q-switch element, FIG. 6(b) is a view in the direction of the arrow D in FIG. 6(a), FIG. 6(c) is a view in the direction of the arrow E in FIG. 6(a), and FIG. 6(d) is a view in the direction of the arrow F in FIG. 6(a);

FIG. 7(a) is a perspective view showing a saturable absorber constituting the Q-switch element shown in FIG. 6, FIG. 7(b) is a perspective view showing a cooling accelerator for the saturable absorber constituting the Q-switch element shown in FIG. 6, and FIG. 7(c) is a perspective view showing a laser medium constituting the Q-switch element shown in FIG. 6;

FIG. 8(a) is a perspective view showing still another manner of practice of a Q-switch element, FIG. 8(b) is a perspective view showing saturable absorbers constituting the Q-switch element shown in FIG. 8(a), and FIG. 8(c) is a view in the direction of the arrow G in FIG. 8(a);

FIG. 9(a) is a perspective view showing an yet further manner of practice of a Q-switch, FIG. 9(b) is a perspective view showing saturable absorbers constituting the Q-switch element shown in FIG. 9(a), FIG. 9(c) is a perspective view showing a cooling accelerator for the saturable absorber constituting the Q-switch element shown in FIG. 9(a), and FIG. 9(d) is a perspective view showing a laser medium constituting the Q-switch element shown in FIG. 9(a); and

FIG. 10 is a graphical representation indicating changes in initial transmittance of a saturable absorber in the case when a light transmits regions wherein concentrations of additives differ from one another in a single saturable absorber.

### DETAILED DESCRIPTION OF THE PREFERRED EMBODIMENTS

In the following, an example of manner of practice of a method for oscillating a variable-pulse width laser and variable-pulse width laser equipment will be described in detail by referring to the accompanying drawings.

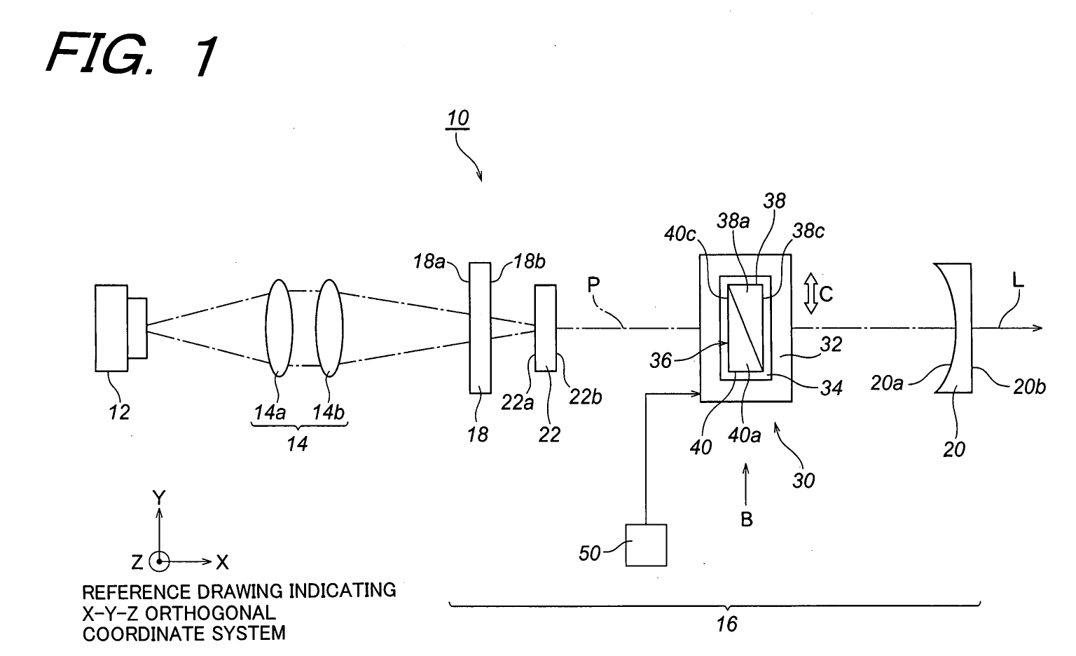

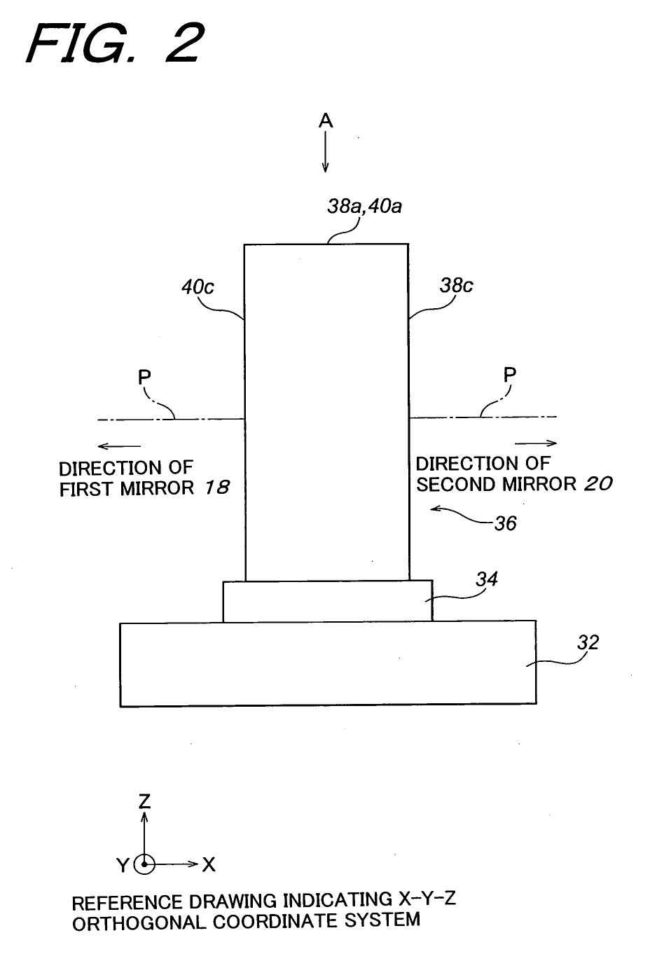

FIG. 1 is a schematic constitutional plan view showing a state wherein variable-pulse width laser equipment according to an example of the manner of practice of the invention is set out on an X-Y plane (see the reference drawing showing the X-Y-Z orthogonal coordinate system in FIG. 1) (a schematic constitution explanatory view taken along the Z-axis and when viewed from the direction of the arrow A in FIG. 2), while FIG. 2 is a schematic constitutional side view showing variable-pulse width laser equipment wherein only a part of a Q-switch unit 30 (which will be mentioned later) is taken out and shown (a schematic constitution explanatory view when viewed from the direction of the arrow B in FIG. 1).

The variable-pulse width laser equipment 10 is composed of a pump laser 12 for producing a pump light, a condensing optical system lens group 14 consisting of two convex lenses 14a and 14b for condensing the pump light produced by the pump laser 12, and a laser resonator 16 to which lights collected by the condensing optical system lens group 14 are input.

The laser resonator 16 is composed of two mirrors of a first mirror 18 and a second mirror 20 opposed to each other wherein the first mirror 18 is placed on the input side of the pump light, i.e. juxtaposed to the condensing optical system lens group 14, while from the second mirror 20 a pulsed laser radiation L is output. The first mirror 18 and the second mirror 20 possess predetermined reflectances and transmittances, respectively.

The first mirror 18 is a plane mirror having both flat surfaces of a surface 18a opposed to the condensing optical system lens group 14 and a surface 18b opposed to the second mirror 20. On one hand, the second mirror 20 is a concave mirror having a surface which is opposed to the surface 18b of the first mirror 18 and is formed into a concave surface 20a having a predetermined curvature radius, while the other surface is formed into a flat surface 20b.

Furthermore, a laser medium 22 is juxtaposed to the first mirror 18 in between the first mirror 18 and the second mirror 20 constituting the laser resonator 16. On one hand, a Q-switch unit is disposed in between the laser medium 22 and the second mirror 20.

A detailed constitution of the Q-switch unit 30 will be described herein. The Q-switch unit 30 is provided with a slide stage 32 which is continuously movable to a direction of an arrow C, i.e. a Y-axis direction being that perpendicular to a light path P of a light proceeding along an X-axis direction in the resonator 16, a holder 34 stood vertically along a Z-axis direction on the slide stage 32 in a detachable manner, and a Q-switch element 36 disposed on the holder 34 to be extended along the Z-axis direction in such that the light path P of the light is positioned inside the holder. The slide stage 32 is arranged to be continuously movable by an arbitrary distance with the use of a driving device 50 involving a driving source such as a motor in the direction of the arrow C along an X-Y plane.

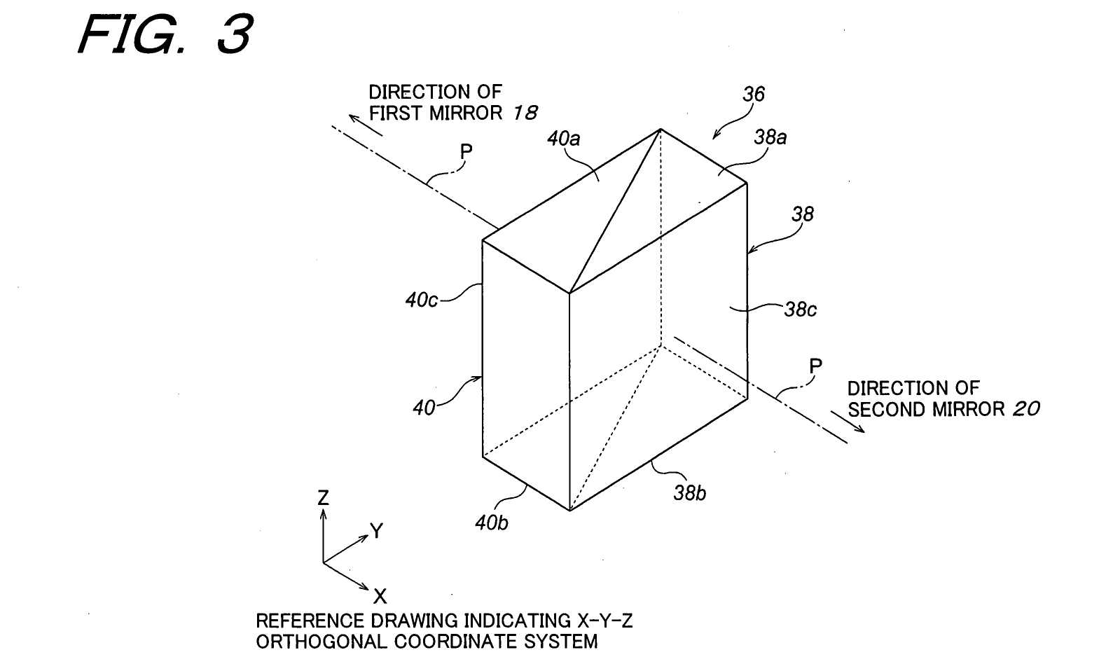

Next, the Q-switch element 36 will be described in detail by referring to FIG. 3 which is a perspective view showing the Q-switch element.

The Q-switch element 36 is composed of a triangular prism-shaped saturable absorber 38 having right triangle-shaped top surface 38a and bottom surface 38b, and a triangular prism-shaped saturable absorber cooling accelerator 40 which has the same triangular prism-shape as that of the saturable absorber 38 and contains right triangle-shaped top surface 40a and bottom surface 40b. Sides corresponding to hypotenuses of the top surface 38a (40a) and the bottom surface 38b (40b) of both the triangular prism-shaped saturable absorber 38 and saturable absorber cooling accelerator 40 are joined together to form a rectangular parallelepiped shape as a whole.

The saturable absorber cooling accelerator 40 is a member for achieving heat diffusion of the saturable absorber 38 to accelerate cooling of the saturable absorber 38. The saturable absorber cooling accelerator 40 has the same or approximate refractive index as that of the saturable absorber 38, and the saturable absorber cooling accelerator 40 is united with the saturable absorber 38 in an optically transparent state.

In the manner of practice, a long side 38c of the triangular prism defined by connecting the top surface 38a and the bottom surface 38b of the saturable absorber 38 and which is at a right angle with a short side of the triangular prism is opposed to the second mirror 20, while a long side 40c of the triangular prism defined by connecting the top surface 40a and the bottom surface 40b of the saturable absorber cooling accelerator 40 and which is at a right angle with a short side of the triangular prism is opposed to the first mirror 18.

Moreover, the Q-switch element 36 is disposed in such that the light path P is positioned vertically with respect to the side 38c of the saturable absorber 38 and the side 40c of the saturable absorber cooling accelerator 40.

In the above-described constitution, when a pump light output from the pump laser 12 is collected by the condensing optical system lens group 14 thereby allowing the pump light thus condensed to input to the laser medium 22 in the laser resonator 16, a pulsed laser radiation L is output from the second mirror 20 due to a function of the saturable absorber 38 constituting the Q-switch element 36 as a Q-switch.

Such a behavior that the pulsed laser radiation L is output from the second mirror 20 based on the function of the above-described saturable absorber 38 as a Q-switch relates to a prior art which has been heretofore known, so that a detailed description therefor is omitted.

When the slide stage 32 is transferred to the direction of the arrow C along the X-Y plane by means of the driving device 50, a thickness of the saturable absorber 38 along the light path P changes, whereby a light path length of a light in the saturable absorber 38 changes wherein the light passes through the saturable absorber 38.

In response to such changes in the light path length in the saturable absorber 38, an initial transmittance of the saturable absorber 38 may be changed, whereby a transmittance of light in the saturable absorber 38 changes to vary a timing of a shutter operation, so that a pulse width of the pulsed laser oscillation L output from the second mirror 20 varies. Accordingly, when a light path length of a light in the saturable absorber 38 is continuously changed by the driving device 50, a pulse width of the pulsed laser oscillation L output from the second mirror 20 changes continuously, while when the light path length of the light in the saturable absorber 38 is changed step-by-step by means of the driving device 50, the pulse width of the pulsed laser oscillation L output from second mirror 20 changes step-by-step.

In the above case, since heat diffusion of the saturable absorber 38 is carried out by means of the saturable absorber cooling accelerator 40 to accelerate cooling of the saturable absorber 38, an influence of heat upon the saturable absorber 38 is suppressed.

Furthermore, when the saturable absorber cooling accelerator 40 is joined to the saturable absorber 38, the whole outline of the Q-switch element 36 comes to be in a rectangular parallelepiped shape, whereby the Q-switch element 36 can be easily attached to the holder 34.

Thus, a pulse width of pulsed laser radiation to be output can be changed continuously or in incremental steps by means of the single saturable absorber 38 which achieves Q-switch functions disposed in the laser resonator 16 according to the variable-pulse width laser equipment 10 wherein such change of the pulse width of pulsed laser radiation could not have been achieved heretofore unless a saturable absorber disposed in a laser resonator as a Q-switch is exchanged by another saturable absorber.

As a result of using the variable-pulse width laser equipment 10 as described above, it becomes possible to reduce a scale of the whole equipment, a degree of freedom in case of designing the variable-pulse width laser equipment can be dramatically increased, and the equipment is excellent in workability and exhibits good convenience, besides there is no need to provide any electrical component which will be a heat source in the laser resonator 16, so that there is no fear of decreasing stability in pulse laser oscillation.

Next, experimental results wherein the variable-pulse width laser equipment 10 is used by the inventor of this application will be described. In the experiment, the variable-pulse width laser equipment 10 having the following constitution is specifically used.

Namely, a semiconductor laser is used as the pump laser 12 wherein it is arranged to output a pump light having 879 nm wavelength.

As the laser medium 22, a Nd:GdVO₄ crystal cut into a size of “4 mm length×4 mm breadth×1 mm thickness” is used. In the experiment, furthermore an antireflection coating which becomes irreflective with respect to a light having 1063 nm wavelength is applied on the surface 22a of the laser medium 22 being the Nd:GdVO₄ crystal wherein the surface 22a is opposed to the first mirror 18, and the antireflection coating is also applied on the surface 22b of the laser medium 22 which is opposed to the second mirror 20.

Next, the first mirror 18 constituting the laser resonator 16 is a total reflection mirror wherein an antireflection coating is applied on the surface 18a so as to be irreflective with respect to a light having 879 nm wavelength, while a total reflection coating is applied on the surface 18b so as to be totally reflective with respect to a light having 1063 nm wavelength.

On one hand, the second mirror 20 constituting the laser resonator 16 is a partial reflection mirror wherein a semitransmissive coating through which 30% of a light having 1063 nm wavelength transmits is applied on the concave 20a, while no coating is applied on the flat surface 20b.

The holder 34 made of copper is used for promoting heat dissipation of the Q-switch element 36.

Furthermore, a Cr:YAG single crystal having a composition wherein a Cr concentration is 0.5% is used for the saturable absorber 38 in the Q-switch element 36, while a nondoped YAG single crystal to which no Cr is added is used for the saturable absorber cooling accelerator 40 in the Q-switch element 36. The saturable absorber 38 is joined to the saturable absorber cooling accelerator 40 in accordance with a well-known optical contact manner.

In the experiment, input power of a pump light is controlled in such that an average value of output power of the pulsed laser radiation L output from the second mirror 20 is 4 W.

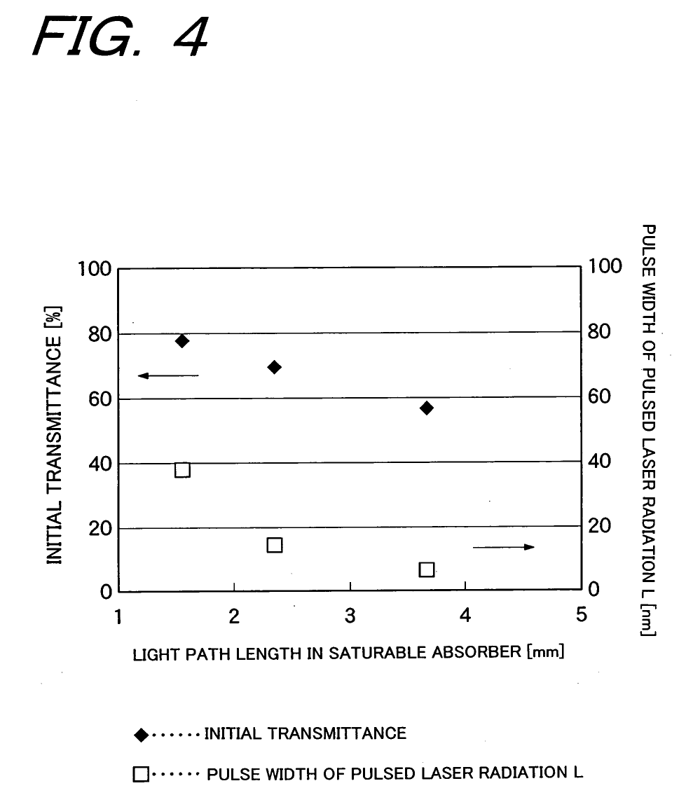

The variable-pulse width laser equipment 10 having the constitution as described above is used to conduct an experiment wherein the slide stage 32 is transferred by means of the driving device 50 to the direction of the arrow C along an X-Y plane, whereby a light path length in the saturable absorber 38 of a light passing through the saturable absorber 38 is changed. As a result, an initial transmittance of the Q-switch element 36 and a pulse width of the pulsed laser radiation L output from the second mirror 20 are changed as shown in FIG. 4.

More specifically, the longer light path length of a light in the saturable absorber 38 through which the light passes brings about the lower initial transmittance of the Q-switch element 36, besides the shorter pulse width of the pulsed laser radiation L output from the second mirror 20.

It is to be noted that the above-described manner of practice may be modified as in the following paragraphs (1) through (17).

(1) In the above manner of practice, Cr:YAG single crystal is illustrated for the saturable absorber 38 by an example, but the invention is not limited thereto as a matter of course. A suitable material for the saturable absorber such as a Cr:GSGG single crystal, a V:YAG single crystal or a GaAs single crystal, and ceramic crystals may be selected.

(2) In the above-described manner of practice, although a semiconductor laser is used as the pump laser 12, the invention is not limited thereto as a matter of course, but a variety of lasers such as gas lasers and dye lasers, in addition to various semiconductor lasers may be appropriately selected for the pump laser.

(3) In the above manner of practice, although the case of excitation based on the pump light having 879 nm wavelength is described, the invention is not limited thereto as a matter of course. For example, the excitation may be based on a pump light having 808 nm wavelength, and the pump light may be suitably selected in response to a wavelength in an absorption band of a laser medium.

(4) In the above-described manner of practice, although the case wherein an Nd:GdVO₄ crystal is used for the laser medium 22 is described, the invention is not limited thereto as a matter of course. For example, an Nd:YAG crystal, an Nd:YVO₄ crystal or the like may be suitably selected for a laser medium. Moreover, an irreflective coating may be applied on the laser medium 22 in response to a waveband of a pulsed laser radiation to be output as described in the above manner of practice, or such irreflective coating may not be applied.

(5) In the above manner of practice, although a size of “4 mm length×4 mm breadth×1 mm thickness” is illustrated by an example for that of the laser medium 22, the invention is not limited thereto as a matter of course. A size of the laser medium may suitably be changed in response to a specification of a laser. Likewise, a size of a variety of components such as the Q-switch element 36 constituting the variable-pulse width laser equipment may also be appropriately changed in response to a specification of a laser.

(6) The wavelength bands and the transmittances of the coating films applied on the first mirror 18 and the second mirror 20 in the laser resonator 16 illustrated in the above-described manner of practice are only an example, but coating films suitable for appropriate waveband and transmittance may be applied in response to a specification of a laser.

(7) In the above-described manner of practice, a total reflection film is formed on an end surface of the laser medium 22 on the side of the pump laser 12, and a laser resonator may be constituted by the total reflection film and the second mirror 20 in place of the first mirror 18 in the laser resonator 16.

(8) In the above-described manner of practice, a partial reflective film is formed on the surface 38c of the saturable absorber 38, and a laser resonator may be constituted by the first mirror 18 in the laser resonator 16 and the partial reflective film in place of the second mirror 20 in the laser resonator 16.

(9) In the above manner of practice, although the driving device 50 provided with a driving source such as a motor is illustrated as a means for transferring the slide stage 32, the invention is not limited thereto as a matter of course, but a driving device wherein a piezoelectric element or the like is used may suitably be selected as a matter of course.

(10) In the above-described manner of practice, although a manner of optical contact is described as an example of a manner for joining the saturable absorber 38 to the saturable absorber cooling accelerator 40, the manner for joining the saturable absorber 38 to the saturable absorber cooling accelerator 40 is not limited to optical contact as a matter of course. In the case where ceramic crystals are used for the saturable absorber 38 and the saturable absorber cooling accelerator 40, both the members may be joined to each other by means of a compression treatment and the like, or they may be joined by a diffusion bonding method, or may be adhesive bonded by the use of an adhesive and the like.

(11) In the above-described manner of practice, although the saturable absorber 38 is intended to be traveled in a direction perpendicular to the line path P of a light in the laser resonator 16, the invention is not limited thereto as a matter of course, but a direction along which the saturable absorber 38 is to be traveled may be arbitrary.

Moreover, although the saturable absorber 38 is arranged to be traveled with respect to the light path P of a light in the laser resonator 16 in the above manner of practice, the invention is not limited thereto as a matter of course, but locations of the first mirror 18 and the second mirror 20 in the laser resonator 16 are changed, whereby the light path P of the light in the laser resonator 16 may be traveled with respect to the saturable absorber 38.

In brief, the saturable absorber 38 is allowed to travel relatively with respect to the light path P of a light in the laser resonator 16, whereby a light path length in the saturable absorber 38 through which the light passes may be changed.

(12) In the above manner of practice, although the saturable absorber cooling accelerator 40 has the same or approximate refractive index as that of the saturable absorber 38, the invention is not limited thereto as a matter of course, but the saturable absorber 38 may have a different refractive index from that of the saturable absorber cooling accelerator 40.

In other words, when there is such a layout that materials each having the same refractive index are used for the saturable absorber 38 and the saturable absorber cooling accelerator 40, respectively, and the light path P is designed in such that a light is vertically input to and output from surfaces of the Q-switch element 36, i.e. the surface 38c of the saturable absorber 38 and the surface 40c of the saturable absorber cooling accelerator 40, no refraction exists on the light path P, so that locations of the first mirror and the second mirror 20 of the laser resonator may be fixed.

On the other hand, if the saturable absorber 38 has a different refractive index from that of the saturable absorber cooling accelerator 40, the light path P of a light is refracted when the light passes through the saturable absorber 38 and the saturable absorber cooling accelerator 40. In this case, locations of the first mirror 18 and the second mirror 20 in the laser resonator may be determined in response to such refracted light path P as needed.

(13) In the above-described manner of practice, although there is presented such layout that the saturable absorber 40 is located on the side of the first mirror 18 of the laser resonator 16, while the saturable absorber 38 is located on the side of the second mirror 20 of the laser resonator 16, the invention is not limited thereto as a matter of course, but the saturable absorber 38 may be located on the side of the first mirror 16 in the laser resonator 18, while the saturable absorber cooling accelerator 40 may be located on the side of the second mirror 20 in the laser resonator 16.

(14) In the above manner of practice, although such Q-switch element 36 prepared by joining the saturable absorber 38 to the saturable absorber cooling accelerator 40 is used, the invention is not limited thereto as a matter of course.

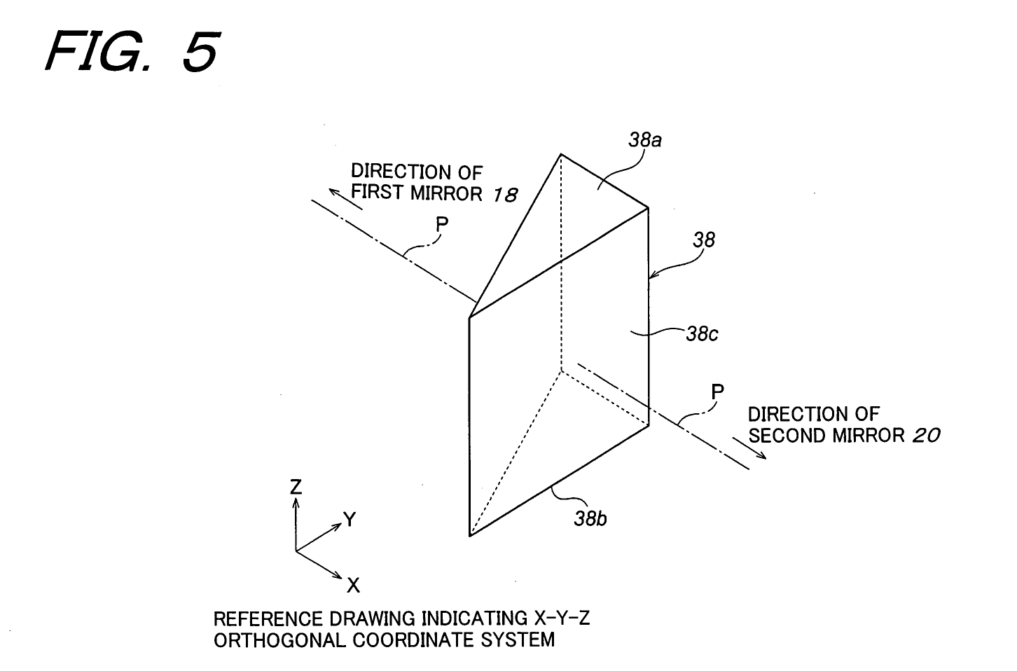

Namely, there is, for example, such a modification as shown in FIG. 5 that the Q-switch element 36 is composed of only the saturable absorber 38 without joint to the saturable absorber cooling accelerator 40, and the resulting Q-switch element 36 may be allowed to function as a Q-switch.

In this case, a constitution of the Q-switch element 36 is simplified, whereby a manufacturing cost in case of manufacturing the Q-switch element can be reduced.

In the case where the Q-switch element 36 is composed of the single saturable absorber 38 as described above, the light path P takes such a route that a light does not vertically input to and output from the saturable absorber 38, so that the light path P is refracted. Thus, in this case, locations of the first mirror 18 and the second mirror 20 in the laser resonator 16 may be determined in response to such light path P as described above as needed.

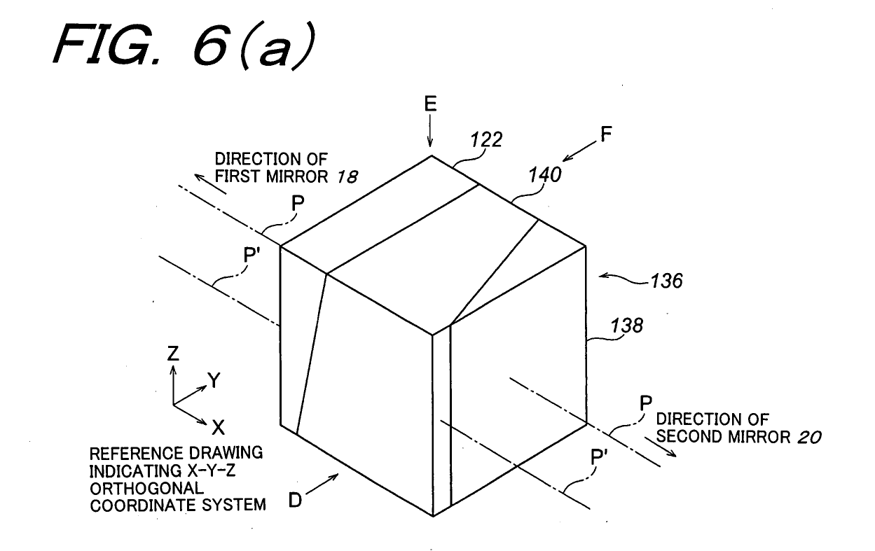

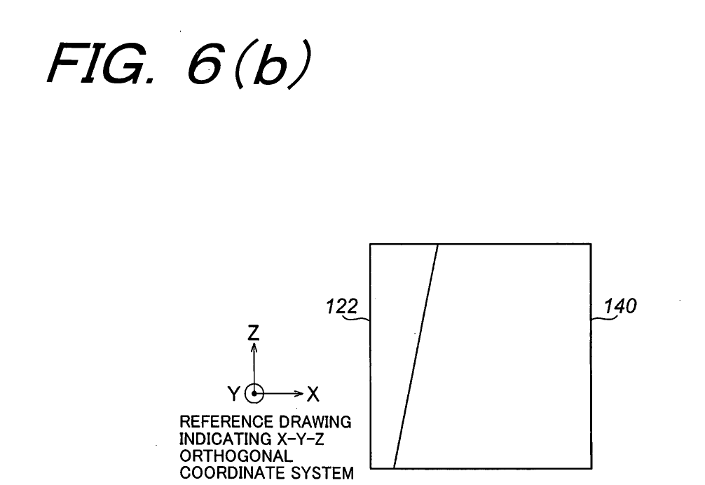

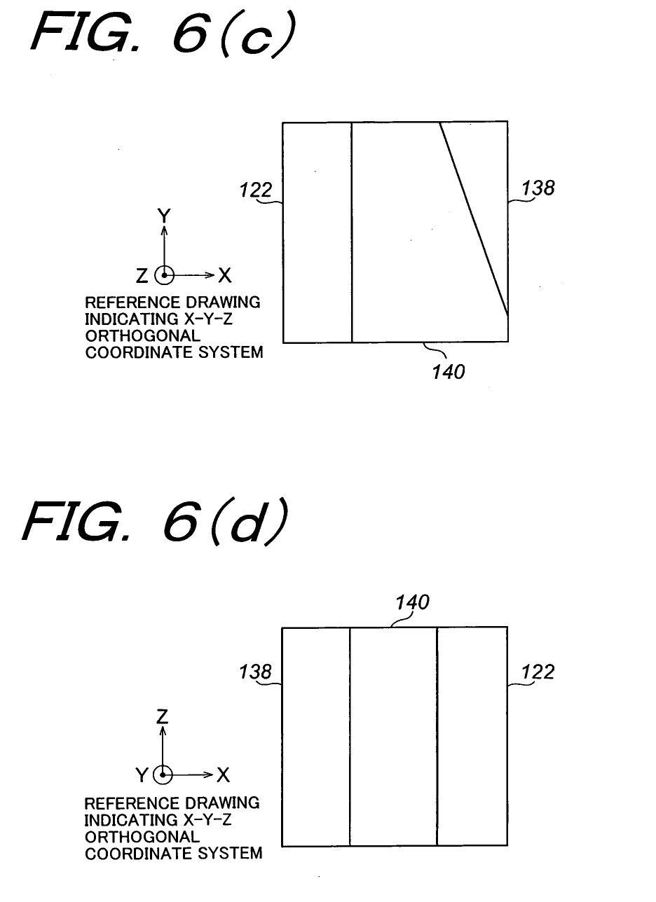

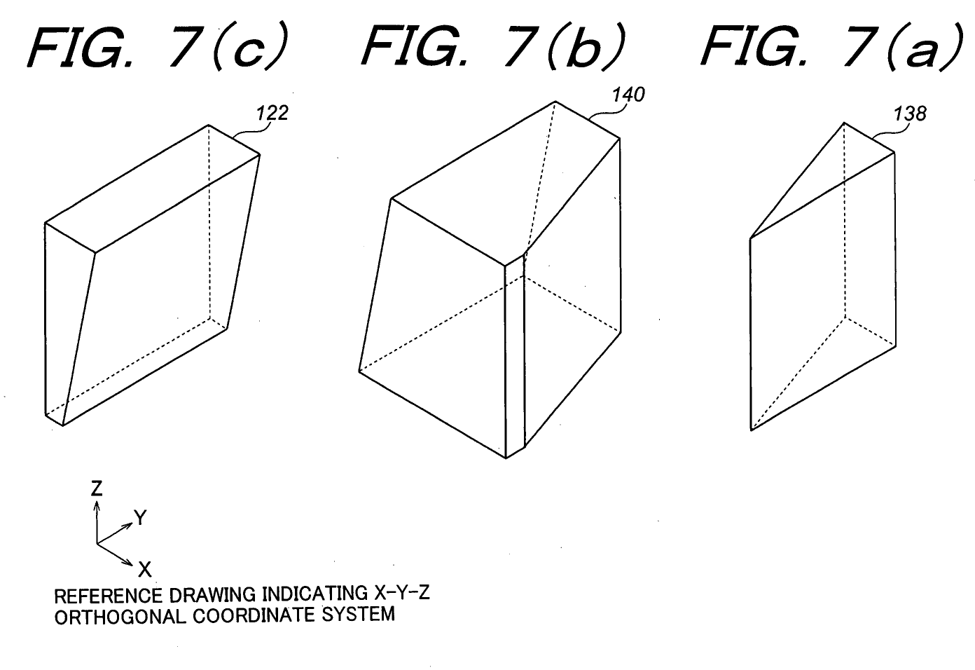

Furthermore, there is, for example, such a modification as shown in FIGS. 6(a) to 6(d) and FIGS. 7(a) to 7(c) that a saturable absorber 138 replaced by the saturable absorber 38 is joined to a saturable absorber cooling accelerator 140 replaced by the saturable absorber cooling accelerator 40, and in addition, a laser medium 122 replaced by the laser medium 22 is joined to the saturable absorber cooling accelerator 140, whereby a Q-switch element 136 replaced by the Q-switch element 36 may be constituted. The Q-switch element 136 shown in FIGS. 6(a) to 6(d) and FIGS. 7(a) to 7(c) may be formed from ceramic elements obtained by a combination of the laser medium 122 made of Nd:YAG, the saturable absorber cooling accelerator 140 made of nondoped YAG, and the saturable absorber 138.

The Q-switch element 136 shown in FIGS. 6(a) to 6(d) and FIGS. 7(a) to 7(c) will be described in detail herein. FIG. 6(a) is a perspective view showing the Q-switch element 136, FIG. 6(b) is a view in the direction of the arrow D in FIG. 6(a), FIG. 6(c) is a view in the direction of the arrow E in FIG. 6(a), and FIG. 6(d) is a view in the direction of the arrow F in FIG. 6(a). On one hand, FIG. 7(a) is a perspective view showing the saturable absorber 138 constituting the Q-switch element 136, FIG. 7(b) is a perspective view showing the saturable absorber cooling accelerator 140 constituting the Q-switch element 136, and FIG. 7(c) is a perspective view showing the laser medium 122 constituting the Q-switch element 136.

The Q-switch element 136 has a rectangular parallelepiped shape as shown in FIG. 6(a), the saturable absorber 138 has a triangular prism shape as shown in FIG. 7(a), the saturable absorber cooling accelerator 140 has a pentagonal prism shape as shown in FIG. 7(b), and the laser medium 122 has a trapezoidal prism shape as shown in FIG. 7(c).

From these components each having a contour as described above, when the Q-switch element 136 is constituted by such an arrangement that the saturable absorber 138 is optically joined to the saturable absorber cooling accelerator 140, and further the laser medium 122 is optically joined to the saturable absorber cooling accelerator 140, cooling for crystals is accelerated. Moreover, in the above-described constitution, when a light path extending through the laser medium 122 and the saturable absorber 138 is allowed to change two-dimensionally along Y-axis and Z-axis directions, light path lengths of the light path P in the laser medium 122 and in the saturable absorber 138 may be independently changed one another. Thus, a pump light absorptivity of the laser medium 122 and an initial transmittance of the saturable absorber 138 may be arbitrarily changed.

In the Q-switch element 136, such a region wherein no saturable absorber 138 is disposed in a plane orthogonal to the light path P is formed. As a result, a light passing through the interior of the laser resonator 16 does not go through the saturable absorber 138 in the case when the light passes through the above-described region, in other words, when the light passes through a light path P′ shown in FIG. 6(a), so that a continuous-wave laser radiation (CW laser radiation) can be output.

More specifically, when the Q-switch element 136 is used, continuous laser oscillation and pulsed laser oscillation having an arbitrary pulse width may be output.

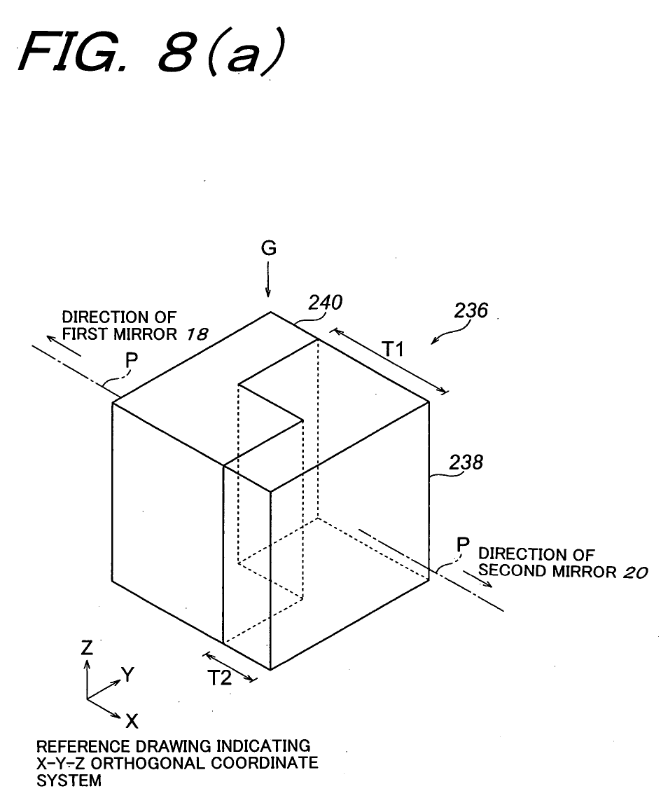

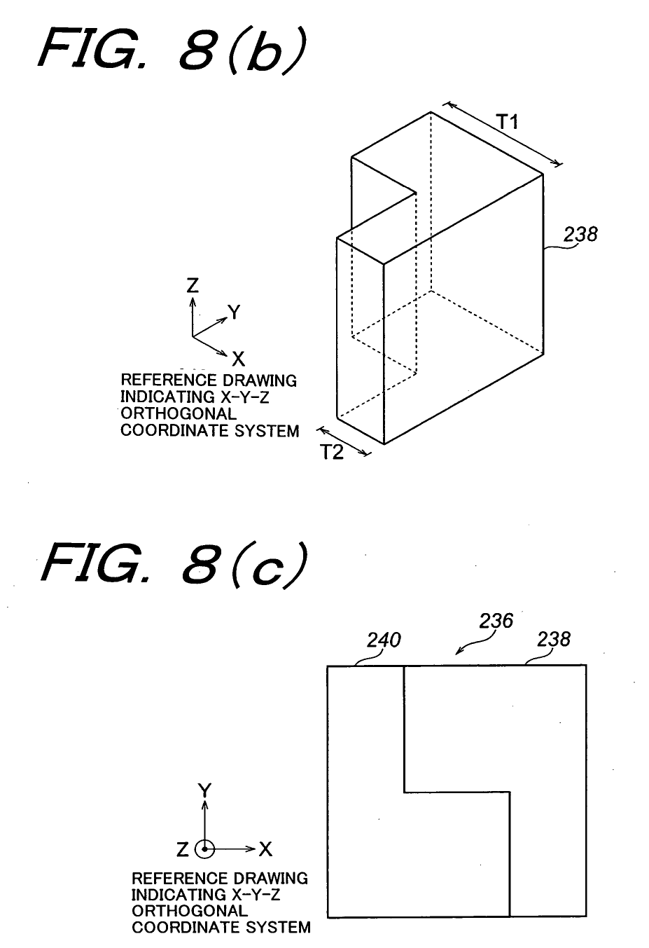

Besides, there is, for example, such a modification as shown in FIGS. 8(a) to 8(c) that a saturable absorber 238 replaced by the saturable absorber 38 is joined to a saturable absorber cooling accelerator 240 replaced by the saturable absorber cooling accelerator 40, whereby a Q-switch element 236 replaced by the Q-switch element 36 may be constituted.

FIG. 8(a) is a perspective view showing the Q-switch element 236, FIG. 8(b) is a perspective view showing the saturable absorber 238, and FIG. 8(c) is a view in the direction of the arrow Gin FIG. 8(a). As is clear from FIGS. 8(a) to 8(c), the saturable absorber 238 is formed in a step-like shape of two steps having thicknesses of T1 and T2 along X-axis direction.

Hence, in the Q-switch element 236, when the Q-switch element 236 is transferred relatively in Y-axis direction with respect to a light path P, the light path P inside the saturable absorber 238 changes in two-stage behavior. Accordingly, when it is intended to switch a pulse width at high speed in two-stage behavior, it is preferred to use the Q-switch element 236.

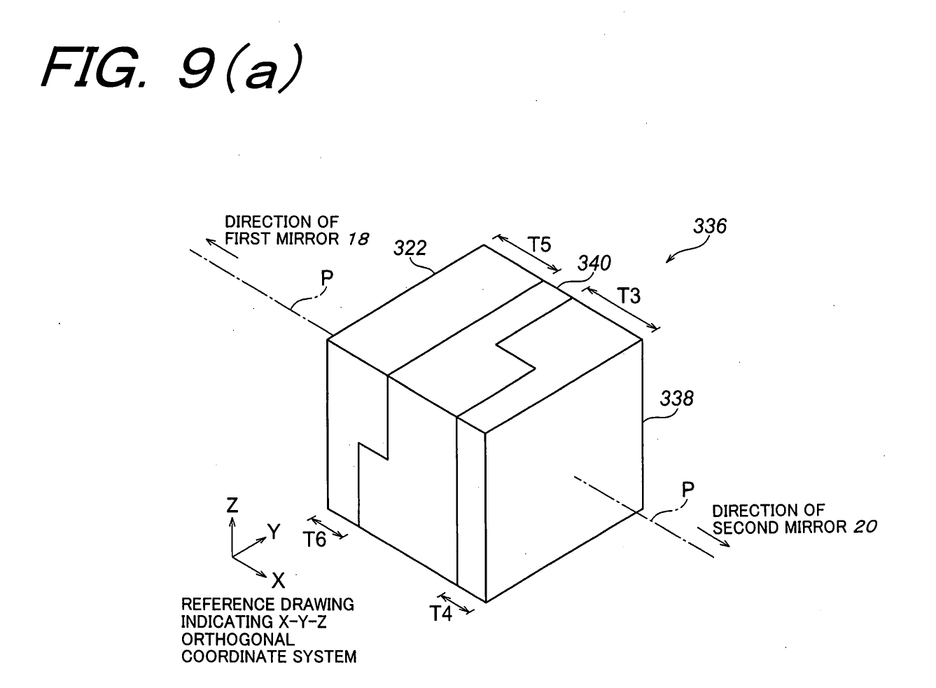

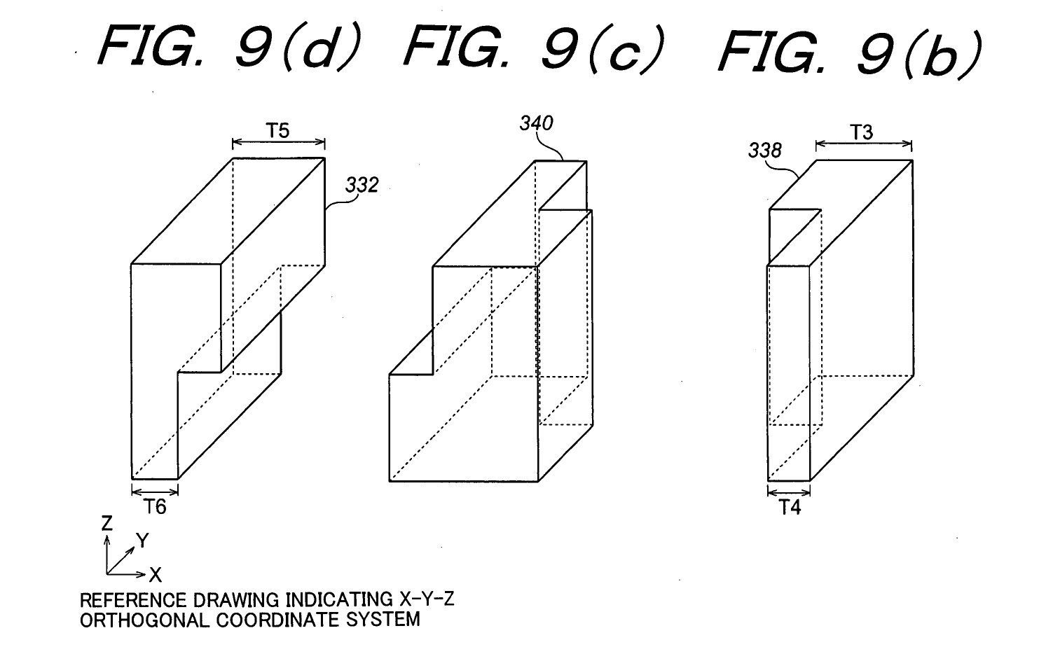

Still further, there is, for example, such a modification as shown in FIGS. 9(a) to 9(d) that a saturable absorber 338 replaced by the saturable absorber 38 is joined to a saturable absorber cooling accelerator 340 replaced by the saturable absorber cooling accelerator 40, and further a laser medium 322 replaced by the laser medium 22 is joined to the saturable absorber cooling accelerator 340, whereby a Q-switch element 336 replaced by the Q-switch element 36 may be constituted.

FIG. 9(a) is a perspective view showing the Q-switch element 336, FIG. 9(b) is a perspective view showing the saturable absorber 338, FIG. 9(c) is a perspective view showing the saturable absorber cooling accelerator 340, and FIG. 9(d) is a perspective view showing the laser medium 322. As is clear from FIGS. 9(a) to 9(d), the saturable absorber 338 is formed in a step-like shape of two steps having thicknesses of T3 and T4 along X-axis direction. Further, the laser medium 322 is formed in a step-like shape of two steps having thicknesses of T5 and T6 along Z-axis direction.

Hence, in the Q-switch element 336, when a light path P passing through the laser medium 322 and the saturable absorber 338 is allowed to change two-dimensionally in Y-axis and Z-axis directions, light lengths of the light path P inside the laser medium 322 and the saturable absorber 338 can be independently changed in two-stage behavior. As a result, a pump light absorptivity of the laser medium 322 and an initial transmittance of the saturable absorber 338 can be changed at high speed in two-stage behavior.

In the above-described Q-switch element 236 as shown in FIGS. 8(a) to 8(c), the initial transmittance of the saturable absorber 238 is adapted to be switched in two-stage behavior, while the pump light absorptivity of the laser medium 322 and the initial transmittance of the saturable absorber 338 are adapted to be switched in two-stage behavior in the Q-switch element 336 shown in FIGS. 9(a) to 9(d). However, the invention is not limited to such modifications as described above as a matter of course, but it may be arranged in such that the saturable absorber 238 or 338, and the laser medium 322 are formed with a stepped shape having an appropriate number of stages, whereby pump light absorptivity of the laser medium, and initial transmittance of the saturable absorber can be switched at a desired stage.

(15) In the above-described manner of practice and the modifications, although shapes of the laser medium, the saturable absorber, and the saturable absorber cooling accelerator are a triangular prism, a pentagonal prism, and a trapezoidal prism, respectively, the invention is not limited thereto as a mater of course, but appropriate shapes may be selected.

(16) In the above-described manner of practice and the modifications, although it is arranged in such that a light path length of a light in a saturable absorber through which the light passes wherein the saturable absorber is disposed in a laser resonator is allowed to change thereby to changing an initial transmittance of the saturable absorber, a manner for changing the initial transmittance of the saturable absorber is not limited to the manner as described above as a matter of course, but an appropriate manner for changing the initial transmittance of a saturable absorber may be selected.

More specifically, there is such a modification for changing the initial transmittance of a saturable absorber that, for example, a concentration of an additive in a single saturable absorber (e.g. Cr in case of using a Cr:YAG single crystal) is allowed to change continuously or step-by-step, whereby its composition is changed in the single saturable absorber, so that the saturable absorber is transferred in such a manner that a light transmits regions having different concentrations of an additive from one another. As a result, the initial transmittance of the saturable absorber may be changed with respect to a light to be input.

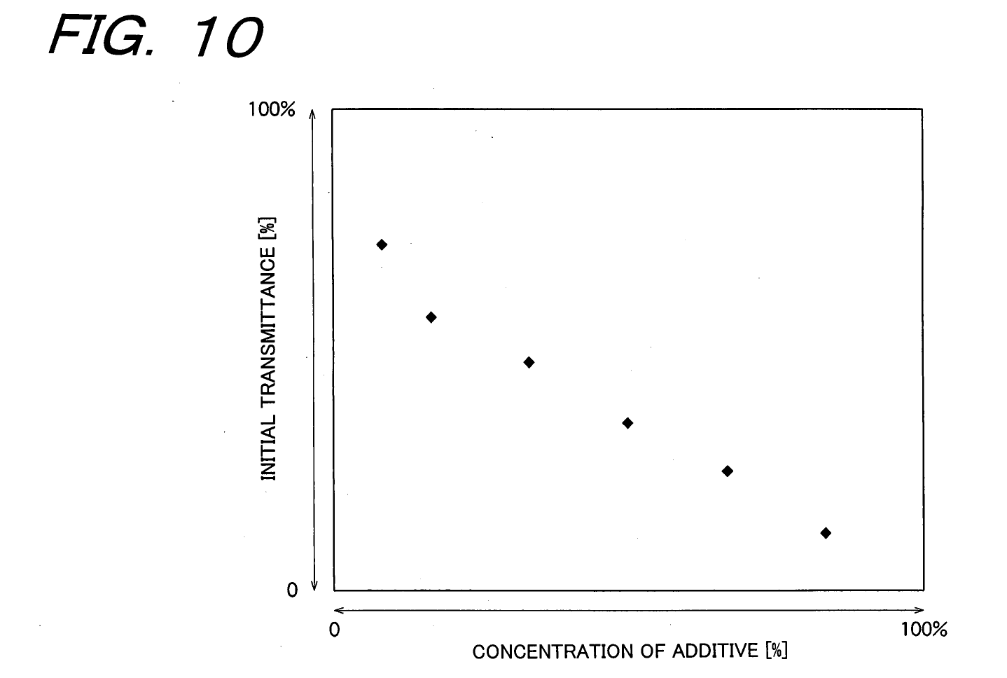

Namely, as is apparent from FIG. 10, when a light transmits regions having different concentrations of an additive in a single saturable absorber, there is such a tendency that the initial transmittance of the saturable absorber decreases with increase in the concentration of the additive in a region wherein the light passes through the saturable absorber.

(17) The above-described manner of practice may be suitably combined with the modifications (1) through (16) as enumerated above.

It will be appreciated by those of ordinary skill in the art that the present invention can be embodied in other specific forms without departing from the spirit or essential characteristics thereof.

The presently disclosed embodiments are therefore considered in all respects to be illustrative and not restrictive. The scope of the invention is indicated by the appended claims rather than the foregoing description, and all changes that come within the meaning and range of equivalents thereof are intended to be embraced therein.

The entire disclosure of Japanese Patent Application No. 2004-372129 filed on Dec. 22, 2004 including specification, claims, drawings and summary are incorporated herein by reference in its entirety.

What is claimed is:

1. A method for oscillating a variable-pulse width laser, comprising the steps of:
disposing a saturable absorber functioning as a Q-switch on a path of a light in a laser resonator provided with a laser medium;
transferring the saturable absorber disposed in the laser resonator relatively toward the path of the light; and
changing an initial transmittance of the saturable absorber in the case when the light passes through the saturable absorber.

2. The method for oscillating a variable-pulse width laser as claimed in claim 1, wherein:
the saturable absorber to which a saturable absorber cooling accelerator is joined in order to diffuse the heat of the saturable absorber.

3. The method for oscillating a variable-pulse width laser as claimed in claim 2, wherein:
the laser medium is united with the saturable absorber cooling accelerator, and is unified with the saturable absorber and the saturable absorber cooling accelerator.

4. Variable-pulse width laser equipment, comprising:
a laser resonator in which a laser medium is disposed;
a saturable absorber which is located on a path of a light inside the laser resonator and functions as a Q-switch; and
a transfer means for transferring the saturable absorber located in the laser resonator relatively toward the path of the light to change an initial transmittance of the saturable absorber in the case when the light passes through the saturable absorber.

5. The variable-pulse width laser equipment as claimed in claim 4, wherein:
the saturable absorber to which a saturable absorber cooling accelerator is joined in order to diffuse the heat of the saturable absorber.

6. The variable-pulse width laser equipment as claimed in claim 5, wherein:
the laser medium is united with the saturable absorber cooling accelerator, and is unified with the saturable absorber and the saturable absorber cooling accelerator.
